(19) United States
(12) Patent Application Publication
(10) Pub. No.: US 2026/0155323 A1
(43) Pub. Date: Jun. 4, 2026

(54) HYBRID CIRCUIT BREAKER AND METHODS FOR OPENING AND CLOSING SUCH A CIRCUIT BREAKER

(71) Applicant: Schneider Electric Industries SAS, Rueil Malmaison (FR)

(72) Inventors: Sébastien HERAUD, GRENOBLE (FR); Rémy ORBAN, SAINT MARTIN D'URIAGE (FR); Emmanuel FRANGIN, GRENOBLE (FR)

(21) Appl. No.: 19/406,073

(22) Filed: Dec. 2, 2025

(30) Foreign Application Priority Data
Dec. 2, 2024 (FR) FR2413280

(51) Int. Cl. H01H 33/12; H01H 33/42

(52) U.S. Cl. CPC H01H 33/125; H01H 33/42

(57) ABSTRACT

Hybrid circuit breaker and methods for opening and closing such a circuit The present invention relates to a hybrid circuit breaker (1) comprising a switching device (5) and a control unit (7). The switching device (5) comprises a main branch (25) comprising a mechanical switch (17), and a switching branch (27) comprising a semiconductor component (19) and an isolating switch (21). The semiconductor component (19) is configured to switch between a conducting configuration and a non-conducting configuration. The isolating switch (21) is configured to switch between a closed configuration and an open configuration. The mechanical switch (17) is configured to switch between a closed configuration, an open configuration, and a disconnect configuration. The resistance to the passage of current in the main branch of the mechanical switch (17) in the disconnect configuration is greater than the resistance to the passage of current in the main branch of the mechanical switch (17) in the open configuration.

### BACKGROUND

The present invention relates to a hybrid circuit breaker. It also relates to a method for closing and to a method for opening such a circuit breaker.

Hybrid circuit breakers are known electrical protection devices combining electronic and mechanical components. In particular, it is known practice to produce a hybrid circuit breaker by placing a semiconductor component and a bypass electromechanical component (also referred to as mechanical switch) in parallel so as to effectively interrupt an excessively strong current while at the same time limiting electrical losses. Furthermore, norms and standards require there to be galvanic isolation between upstream and downstream of the product so as to ensure the absence of a leakage current in the open position and ensure the safety of anybody performing maintenance operations for example. Conventional designs therefore propose an isolating switch in series with the switching device comprising the two parallel branches. Thus, the isolating switch is, in particular, in series with the electromechanical component. The isolating switch performs the function of galvanic isolation, also referred to as the disconnection function. Furthermore, these circuit breakers generally incorporate a voltage-limiting component in parallel with the semiconductor component and with the electromechanical component.

The major disadvantages of such a design are that of increasing losses and dissipation in the product as a result of the contact resistance of the isolating switch, and that of creating a thermal block as a result of the very low thermal conductivity through the contacts of such a switch. The thermal block prevents some of the heat energy from being removed from the product by conduction via the connecting cables, which is the route that usually constitutes most of the cooling in electromechanical electrical distribution products that do not have forced convection or liquid cooling. The isolating switch is therefore responsible for an increase in the internal temperature of the product and for extensive heating of the internal conductors to which the semiconductor component is connected. The temperature of the semiconductor component is therefore significantly impacted as, by extension, is the performance and durability of this component.

Further, the presence of the isolating switch in the line along which the current passes in nominal operation means that the isolating switch has to be rated according to the nominal current in order to ensure acceptable contact resistance. Since the contact resistance is a function of the square of the contact pressure, the contact pressure forces therefore need to increase significantly with the rating of the product, requiring significant control power and contributing to an increase in the physical size of the product.

Another constraint associated with this design is that of preventing repulsion of the contacts of the isolating switch as a result of the electrodynamic forces during the breaking phase, as failure to do so risks degradation of the contact surface or even welding-together of the contacts. Specifically, degradation of the contact resistance would have a deleterious effect on the dissipation of heat and on the disconnection capability of the product. It is therefore necessary to have sufficient electrodynamic strength, which has an indirect effect on the losses of a control actuator and on the volume of the product.

Finally, in architectures of the hybrid type, use is gently made of the switching device to interrupt the current before the opening or closing of the isolating switch which therefore operates under no current. This is particularly advantageous because production is simplified due to the absence of current-breaking constraints. However, this mode of operation never reaps the benefit of the contact “cleaning” effect of the electric arc. This may therefore result in deterioration of the contact resistance during the life of the product and this too will negatively impact the thermal behaviour and performance of the product.

In light of these problems, it will therefore be understood how beneficial it would be to situate the isolating switch outside of the main branch so as to reduce the electrical losses and the dissipation in the product, minimize the operating temperature of the switching device for a given current (or increase the current capacity for the same operating temperature), reduce the sizing constraints (contact forces) for the isolating switch, and overcome the problems whereby the contact resistance drifts as a result of contamination or oxidation.

Document EP3529817 proposes a design in which the isolating switch is situated in the switching branch, thereby addressing the above problems.

However, the solution proposed in document EP3529817 is unable to provide the disconnection function. Specifically, positioning the isolating switch in the switching branch ensures disconnection only of the switching branch, which means that the mechanical switch has to perform the function of providing galvanic isolation of the main branch. Now, the galvanic-isolation distances required for low-voltage products (typically several millimetres for withstanding surge voltages of several kilovolts) make the creation of the mechanical switch significantly more complicated. In particular, these constraints work against the rapid-opening function usually provided by the mechanical switch. Specifically, present-day technologies capable of obtaining high levels of performance in terms of dynamics of opening for this type of function allow movement over only very short distances (e.g. piezoelectric technology) or have very high energy consumption (e.g. Thomson effect technology).

### SUMMARY

The object of the invention is therefore to propose a hybrid circuit breaker that has both the advantages of the positioning of the isolating switch in the switching branch and the disconnection function of the circuit breaker.

To this end, the invention relates to a hybrid circuit breaker comprising:
a switching device comprising a main branch connecting two electrical terminals and a switching branch connecting the two electrical terminals and in parallel with the main branch, the switching device comprising:
   a mechanical switch, belonging to the main branch, configured to switch between a closed configuration allowing current to flow in the main branch, and an open configuration opposing the flow of current in the main branch;
   a semiconductor component, belonging to the switching branch, configured to switch between a conducting configuration allowing current to flow in the switching branch and a non-conducting configuration opposing the flow of current in the switching branch; and
   an isolating switch, belonging to the switching branch, configured to switch by means of an isolation mechanism between a closed configuration allowing current to flow in the switching branch, and an open configuration opposing the flow of current in the switching branch, the isolating switch having, in the open configuration, a resistance to the passage of current in the switching branch that is higher than a resistance to the passage of current in the switching branch of the semiconductor component in the non-conducting configuration;
   a control unit, configured to command a switching of the mechanical switch between its open configuration and its closed configuration, of the semiconductor component between its non-conducting configuration and its conducting configuration, and of the isolating switch between its closed configuration and its open configuration via the isolation mechanism, depending on the incoming current passing through the hybrid circuit breaker between the two electrical terminals;
the mechanical switch also being able to switch, by means of the isolation mechanism, into a disconnect configuration, distinct from the open configuration and from the closed configuration, that opposes the flow of current in the main branch, and such that a resistance to the passage of current in the main branch of the mechanical switch in the disconnect configuration is greater than the resistance to the passage of current in the main branch of the mechanical switch in the open configuration.

By virtue of the invention, the switching of the mechanical switch between the closed configuration and the open configuration allows rapid opening of the main branch, while the switching into the disconnect configuration is able to provide the function of disconnecting the main branch. Thus, by being switched in two stages, the mechanical switch is able to combine the two functions. The isolating switch, positioned in the switching branch, performs the disconnection function in the switching branch, which does not have current passing through it during nominal operation. Thus, the hybrid circuit breaker according to the invention offers all of the aforementioned advantages of positioning the isolating switch outside of the main branch, while still performing the function of disconnecting the product.

According to other advantageous aspects of the invention, the hybrid circuit breaker comprises one or more of the following features, taken alone or in any technically possible combinations:
the isolation mechanism is further configured to be tripped by manual action by an operator;
the isolation mechanism is configured to be tripped only by the control unit;
the hybrid circuit breaker further comprises a locking device configured to prevent the isolation mechanism from switching the mechanical switch into one of its open or closed configurations and the isolating switch into its closed configuration in the absence of confirmation from the control unit;
the hybrid circuit breaker further comprises a trip unit configured to receive a measurement of the incoming current and to command the isolation mechanism to switch the mechanical switch into its disconnect configuration and the isolating switch into its open configuration when the incoming current exceeds a predetermined current threshold;
the mechanical switch is bistable, i.e. the open configuration and the closed configuration of the mechanical switch are stable;
the mechanical switch is monostable;
the hybrid circuit breaker further comprises a screen opposing the flow of current in the main branch when the mechanical switch is in its disconnect configuration.

The invention also relates to a method for opening a hybrid circuit breaker according to the foregoing, the mechanical switch being initially in its closed configuration, the semiconductor component in its conducting configuration and the isolating switch in its closed configuration, the opening method comprising:
a first phase of opening, comprising a switching of the mechanical switch from its closed configuration to its open configuration then a switching of the semiconductor component from its conducting configuration to its non-conducting configuration; then
a second phase of opening, comprising a switching of the isolating switch from its closed configuration to its open configuration and a switching of the mechanical switch from its open configuration to its disconnect configuration.

The invention also relates to a method for closing a hybrid circuit breaker according to the foregoing, the mechanical switch being initially in its disconnect configuration, the semiconductor component in its non-conducting configuration and the isolating switch in its open configuration, the closing method comprising:
a first phase of closing, comprising a switching of the mechanical switch from its disconnect configuration to its open configuration and a switching of the isolating switch from its open configuration to its closed configuration; then
a second phase of opening, comprising a switching of the semiconductor component from its non-conducting configuration to its conducting configuration then a switching of the mechanical switch from its open configuration to its closed configuration.

### BRIEF DESCRIPTION OF DRAWINGS

The invention will become more clearly apparent upon reading the following description, which is proved solely by way of a non-limiting example, and with reference to the drawings, in which:

FIG. 1 is a diagram of a hybrid circuit breaker according to a first embodiment of the invention;

FIGS. 2A to 2D are diagrams of a monostable mechanical switch belonging to a hybrid circuit breaker according to two alternative forms of the invention;

FIG. 3 is a diagram of a hybrid circuit breaker according to a second embodiment of the invention;

FIG. 4 is a diagram of a hybrid circuit breaker according to a third embodiment of the invention;

FIG. 5 is a diagram of a hybrid circuit breaker according to a fourth embodiment of the invention;

FIG. 6 is a timing diagram of a method for closing and then opening the hybrid circuit breaker of FIG. 1, 2, 3 or 4.

### DETAILED DESCRIPTION

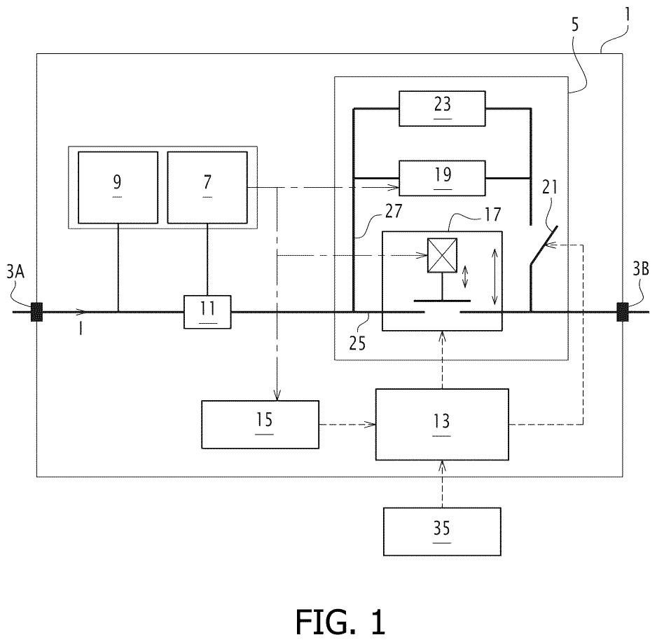

FIG. 1 depicts a hybrid circuit breaker 1 configured to be inserted in an electrical installation, not depicted, and to ensure the safety of this electrical installation by interrupting an incoming current I flowing through the hybrid circuit breaker 1 when this incoming current I exceeds a predetermined current threshold.

In particular, the hybrid circuit breaker 1 comprises two electrical terminals 3A and 3B via which the hybrid circuit breaker 1 is connected to the electrical installation. In nominal operation, i.e. when the hybrid circuit breaker 1 is not interrupting the current I, the incoming current I reaches the electrical installation via one of the electrical terminals 3A, passes through the hybrid circuit breaker 1 and re-emerges in the electrical installation via the other electrical terminal 3B.

The hybrid circuit breaker 1 comprises a switching device 5, a control unit 7 and an isolation mechanism 13. Advantageously, the hybrid circuit breaker 1 further comprises an electrical power supply 9, a current sensor 11 and a trip unit 15.

The switching device 5 has the function of interrupting or of re-establishing the passage of current I between the two electrical terminals 3A and 3B.

In order to do so, the switching device 5 comprises a mechanical switch 17, a semiconductor component 19 and an isolating switch 21. Advantageously, the switching device 5 further comprises a voltage-limiting component 23.

These components are divided between a main branch 25 and a switching branch 27. One branch is an electrical-circuit portion comprising at least one component connected to electrically conducting wires.

The main branch 25 connects the two electrical terminals 3A and 3B.

The mechanical switch 17 belongs to the main branch 25 and its purpose is to provide both rapid opening and galvanic isolation of the main branch 25. In order to do this, the mechanical switch 17 is configured to switch between a closed configuration that allows current flow in the main branch 25, an open configuration that opposes the flow of current in the main branch 25, and a disconnect configuration, distinct from the open configuration and from the closed configuration, that likewise opposes the flow of current in the main branch 25. The mechanical switch 17 is such that the resistance to the passage of current in the main branch 25 of the mechanical switch 17 in the disconnect configuration is greater than the resistance to the passage of current in the main branch 25 of the mechanical switch 17 in the open configuration.

The mechanical switch 17 is either monostable or bistable. What is meant by monostable is that only one of the three—closed, open or disconnect—configurations is stable without the input of external energy. What is meant by bistable is that the two—open and closed—configurations are stable without the input of external energy. In the embodiment of FIG. 1, the mechanical switch is bistable.

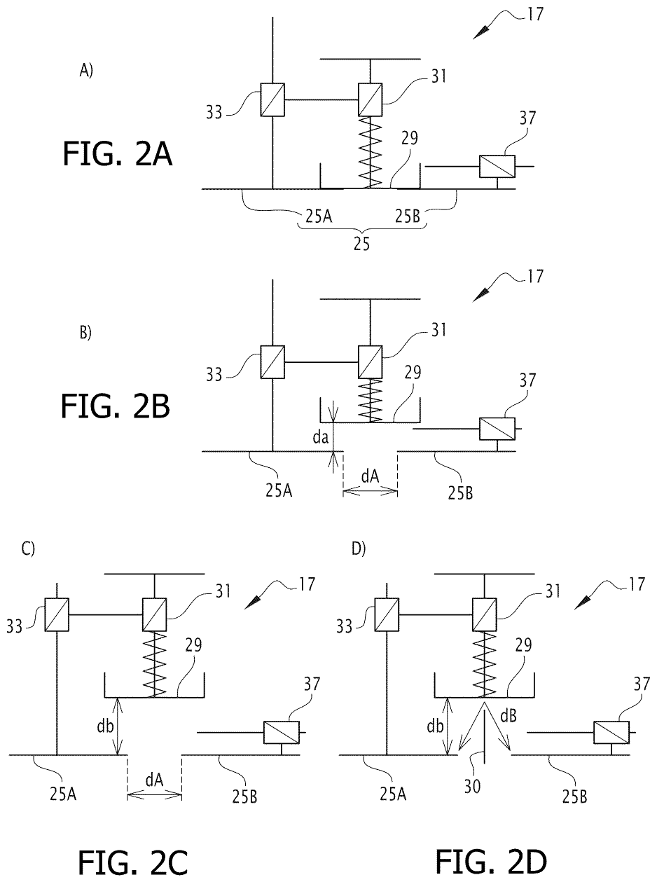

FIGS. 2A to 2D illustrate one embodiment of a monostable mechanical switch 17. The mechanical switch 17 is depicted in the closed configuration in insert A, in the open configuration in insert B, in the disconnect configuration according to a first alternative form of the invention in insert C, and in the disconnect configuration according to a second alternative form of the invention in insert D of FIGS. 2A to 2D.

As is clearly visible in FIGS. 2A to 2D, the mechanical switch 17 comprises a contactor 29 which, depending on the configuration of the mechanical switch 17, either makes or does not make a physical connection between two distinct portions 25A and 25B of the main branch 25, these portions being respectively upstream and downstream of the mechanical switch 17.

When the mechanical switch 17 is in the closed configuration, the contactor 29 physically connects the two portions 25A and 25B, allowing current to flow through the main branch 25.

When the mechanical switch 17 is in the open or disconnect configuration, the contactor 29 is at a non-zero respective distance da or db from the main branch 25, so that the two portions 25A and 25B are no longer physically connected. The mechanical switch 17 thus opposes the flow of current in the main branch 25.

Furthermore, the distance da between the main branch 25 and the contactor 29 in the open configuration is less than the distance db between the main branch 25 and the contactor 29 in the disconnect configuration. This makes it possible to guarantee that the resistance to the passage of current in the main branch 25 of the mechanical switch 17 in the disconnect configuration is greater than the resistance to the passage of current in the main branch 25 of the mechanical switch 17 in the open configuration.

Specifically, the degree of isolation of the mechanical switch 17, i.e. the resistance to the passage of current through the main branch 25, is determined by the lesser of a distance dA between the two portions 25A and 25B and twice the distance da or db between the main branch 25 and the contactor 29.

According to the first alternative form of the invention that is depicted in inserts A, B and C, twice the distance da separating the contactor 29 in the open configuration from the branch 25 is less than the distance dA between the portions 25A and 25B. The isolation afforded by the mechanical switch 17 in the open position is therefore determined by twice the distance da. In the disconnect configuration, the distance dA between the portions 25A and 25B is less than twice the distance db separating the contactor 29 from the branch 25. The isolation afforded by the mechanical switch 17 in the disconnection position is therefore determined by the distance dA. Since the distance dA between the portions 25A and 25B is greater than twice the distance da between the contactor 29 in the open configuration of the branch 25, the isolation afforded by the mechanical switch 17 in the disconnection position is indeed greater than the isolation afforded by the mechanical switch 17 in the open position.

According to the second alternative form of the invention that is depicted in insert D, the circuit breaker 1 further comprises a screen 30 opposing the flow of current in the main branch 25 when the mechanical switch 17 is in its disconnection position. The screen 30 is for example a component made from a non-conducting material, for example plastic, which is inserted between the two portions 25A and 25B of the main branch 25 when the mechanical switch 17 is in the disconnection position. The degree of isolation is then determined by the lesser of twice the distance db between the contactor 29 and the main branch 25 and a distance dB of the shortest pathway through the air between the two portions 25A and 25B. Since the distance dB when the screen 30 is present is greater than the distance dA when the screen 30 is absent, it will be appreciated that the screen 30 makes it possible to increase the resistance to the passage of current in the main branch 25 when the mechanical switch 17 is in the disconnection position or to reduce the distance db needed for disconnection.

Advantageously, the mechanical switch 17 is switched between its various configurations by two separate actuators 31 and 33. More specifically, an opening actuator 31 actuates the switching of the mechanical switch 17 between its open configuration and its closed configuration, whereas a disconnection actuator 33 actuates the switching of the mechanical switch 17 between one of its open or closed configurations and its disconnect configuration. In the second alternative form of the invention, the screen 30 is for example actuated by the disconnection actuator 33, or by a third actuator, not depicted, similar to the disconnection actuator 33.

Advantageously, the opening actuator 31 and disconnection actuator 33 are independent of one another. Advantageously, the opening actuator 31 is faster than the disconnection actuator 33. In other words, the switch from the closed configuration to the open configuration is more rapid than the switch from the closed configuration to the disconnect configuration. In particular, the opening actuator 31 confers upon the mechanical switch 17 a speed of switching from the closed configuration to the open configuration that is at least equal to the speed of opening of conventional hybrid circuit breaker electromechanical components.

In FIGS. 1, 3, 4 and 5, lines drawn using chain line indicate electrical connections between the components, and lines drawn in regular dotted line indicate mechanical connections between components or between a component and an operator 35 external to the hybrid circuit breaker 1.

In the example of FIG. 1, the opening actuator 31, and therefore the switching of the mechanical switch 17 between the closed configuration and the open configuration, is brought about electronically by the control unit 7. Still in this example, the disconnection actuator 33, and therefore the switching of the mechanical switch 17 between one of its open or closed configurations and the disconnect configuration, is brought about mechanically by the isolation mechanism 13.

The switching branch 27 connects the two electrical terminals 3A and 3B and is in parallel with the main branch 25. The semiconductor component 19 and the isolating switch 21 belong to this switching branch 27. In the example of FIG. 1, the switching branch 27 comprises two sub-branches one in parallel with the other, the first sub-branch comprising the semiconductor component 19 and the second sub-branch comprising the voltage-limiting component 23.

The semiconductor component 19 has the function of ensuring rapid opening of the switching branch 27. To do that, the semiconductor component 19 is configured to switch between a conducting configuration allowing current to flow in the switching branch 27, and a non-conducting configuration opposing the flow of current in the switching branch 27. The semiconductor component 19 is for example at least one transistor, such as a FET (Field Effect Transistor), a MOSFET (Metal Oxide Semiconductor Field Effect Transistor), a bipolar transistor, or combination of these various transistors.

In the example of FIG. 1, the switching of the semiconductor component 19 between its conducting configuration and its non-conducting configuration is brought about electronically by the control unit 7.

The isolating switch 21 has the function of ensuring galvanic isolation of the switching branch 27. To do that, the isolating switch 21 is configured to switch between a closed configuration allowing current to flow in the switching branch 27, and an open configuration opposing the flow of current in the switching branch 27. Furthermore, the isolating switch 21 in the open configuration has a resistance to the passage of current in the switching branch 27 that is higher than a resistance to the passage of current in the switching branch 27 of the semiconductor component 19 in the non-conducting configuration. In practice, this resistance to the passage of current is obtained by physically distancing two portions of the switching branch 27 that are upstream and downstream of the isolating switch 21.

In the example of FIG. 1, the switching of the isolating switch 21 between its closed configuration and its open configuration is brought about mechanically by the isolation mechanism 13.

The voltage-limiting component 23 has the function of limiting the voltage spikes that may occur between the electrical terminals 3A and 3B when the current I is interrupted. In so doing, the voltage-limiting component 23 protects the mechanical switch 17 and the semiconductor component 19 against these potential overvoltages. The voltage-limiting component 23 is for example a metal oxide varistor. The metal oxide varistor has a high resistance when the voltage across its terminals is low, so that the current does not flow in that sub-branch of the switching branch 27 that contains the voltage-limiting component 23. When the voltage across its terminals crosses a certain voltage threshold, the resistance of the metal oxide varistor drops drastically, so that the current is diverted towards that sub-branch of the switching branch 27 that comprises the voltage-limiting component 23.

As depicted in FIG. 1, the isolating switch 21 is situated in the switching branch 27 but belongs neither to the sub-branch comprising the semiconductor component 19 nor to the sub-branch comprising the voltage-limiting component 23, which means that a current passing through one or the other of these components also passes through the isolating switch 21. Thus, the isolating switch 21 does indeed perform the function of galvanically isolating the entirety of the switching branch 27 when it switches into the open configuration. Conversely, when the isolating switch 21 is closed, the two sub-branches of the switching branch 27 and the main branch 25 are in parallel which means that the voltage-limiting component 23 protects both the semiconductor component 19 and the mechanical switch 17 against overvoltage.

The current sensor 11 has the function of measuring a value of the incoming current I and of transmitting this value to the control unit 7. The current sensor 11 is advantageously situated between the first terminal 3A and the switching device 5. The current sensor 11 may be any device known to those skilled in the art and able to measure a current.

The control unit 7 is configured to electronically command a switching of the mechanical switch 17 between its open configuration and its closed configuration and of the semiconductor component 19 between its non-conducting configuration and its conducting configuration, depending on the current-strength value measured and transmitted by the current sensor 11. Advantageously, the control unit 7 is also configured to electronically command the isolation mechanism 13 via the trip unit 15. As an alternative, the control unit 7 commands the isolation mechanism 13 directly.

The control unit 7 is an electronic circuit designed to manipulate and/or convert data represented by electronic or physical quantities in registers of the control unit and/or in memories into other similar data corresponding to physical data in the memories of registers or other types of display device, transmission device or memory-storage device.

By way of specific examples, the control unit 7 is implemented in the form of a programmable logic component, such as an FPGA (Field Programmable Gate Array), or even in the form of a dedicated integrated circuit, such as an ASIC (Application Specific Integrated Circuit).

In the example of FIG. 1, the control unit 7 is electrically powered by the electrical power supply 9.

The trip unit 15 has the function of mechanically commanding the isolation mechanism 13 according to the electronic command received by the control unit 7. In other words, the trip unit 15 converts an electronic command received from the control unit 7 into a mechanical command for the isolation mechanism 13.

The isolation mechanism 13 has the function of commanding the galvanic-isolation functions of the switching device 5. In other words, the isolation mechanism 13 is configured to cause the isolating switch 21 to switch between its closed configuration and its open configuration and the mechanical switch 17 to switch between one of its open or closed configurations and its disconnect configuration. In order to do this, the isolation mechanism 13 comprises actuators, not depicted, configured to act mechanically on the mechanical switch 17 and on the isolating switch 21.

According to one example which has not been illustrated, the aforementioned disconnection actuator 33 does not belong to the mechanical switch 17 but belongs to the isolation mechanism 13.

A configuration in which the mechanical switch 17 is in its disconnect configuration and the isolating switch 21 is in its open configuration is referred to as the open configuration of the isolation mechanism 13. The open configuration of the isolation mechanism 13 provides galvanic isolation of the entirety of the hybrid circuit breaker 1.

A configuration in which the mechanical switch 17 is in its open configuration or in its closed configuration and the isolating switch 21 is in its closed configuration is referred to as the closed configuration of the isolation mechanism 13.

The isolation mechanism 13 is commanded by the control unit 7, either directly or via the trip unit 15, as described hereinabove.

In the embodiment of FIG. 1, the isolation mechanism 13 is further configured to be tripped by manual action by the operator 35. The two ways of controlling the isolation mechanism 13—by the control unit 7 or by the operator 35—therefore coexist. Advantageously, command by means of the control unit 7 enables the isolation mechanism 13 to be switched from its closed configuration to its open configuration, whereas command by the operator 35 enables the isolation mechanism 13 to be switched the other way, from its open configuration to its closed configuration.

It is then said that command by the control unit 7 has the function of disabling the switching device 5, whereas command by the operator 35 has the function of resetting the switching device 5.

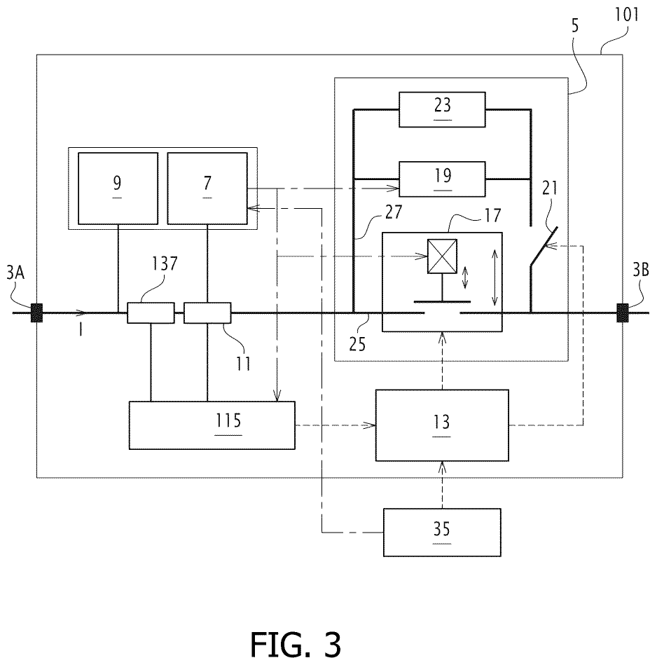

FIG. 3 relates to a hybrid circuit breaker 101 according to a second embodiment of the invention. This hybrid circuit breaker 101 is identical to the hybrid circuit breaker 1 of FIG. 1, except for the differences mentioned hereinafter. Those features of the hybrid circuit breaker 101 that are identical to, or that operate in the same way as, those of the hybrid circuit breaker 1 bear the same reference symbol. Those features that are modified bear a reference symbol increased by 100.

The hybrid circuit breaker 101 differs from the hybrid circuit breaker 1 in that it comprises a trip unit 115, which replaces the trip unit 15, which is configured to receive a measurement of the incoming current I and to command the isolation mechanism 13 to switch the mechanical switch 17 into its disconnect configuration and the isolating switch 21 into its open configuration when the incoming current I exceeds the predetermined current threshold.

More specifically, the trip unit 115 is connected to the current sensor 11 so as to receive the current-strength value measured by this current sensor 11 and generate a mechanical command intended for the isolation mechanism 13 in the event of an overcurrent being detected, independently of the control unit 7.

This additional functionality makes it possible to ensure that the current I is interrupted in the event of an overcurrent even if there is a malfunction of the control unit 7, of the electrical power supply 9 or of the switching device 5. In other words, this second embodiment introduces redundancy into the tripping of the isolation mechanism 13, thereby improving the safety and the reliability of the hybrid circuit breaker 1.

Advantageously, the trip unit 115 is supplied with current via a current supply 137 configured to supply the trip unit 115 with the incoming current I.

Thus, the hybrid circuit breaker 101 is able to detect and interrupt a current, within the limits of the switching capability associated with the switching of the isolation mechanism 13 from its closed position to its open position, without the need to be powered.

The hybrid circuit breakers 1 and 101 described hereinabove with reference to FIGS. 1 and 3 are able to provide the function of galvanic isolation of the switching device 5 while offering the advantages mentioned in the introduction of positioning the isolating switch 21 in the switching branch 27. Another problem addressed by such a hybrid circuit breaker is that of providing safe operation even in the event of failure of a component of the hybrid circuit breaker. More specifically, this means ensuring that a current can be established or that the current can be re-established following a breaking of the current, only if the hybrid circuit breaker is operational.

In the two embodiments described hereinabove, the fact that the mechanical switch 17 is bistable allows this safe operation to be assured. Specifically, since the open configuration of the mechanical switch 17 is stable, the sequence of operations that will be described later on in the description ensures that the mechanical switch 17 is indeed in its open configuration after the switching device 5 is reset by the isolation mechanism 13. That allows control over the sequence whereby a flow of current is established and avoids the flow of current being established if the hybrid circuit breaker 1 or 100 is faulty.

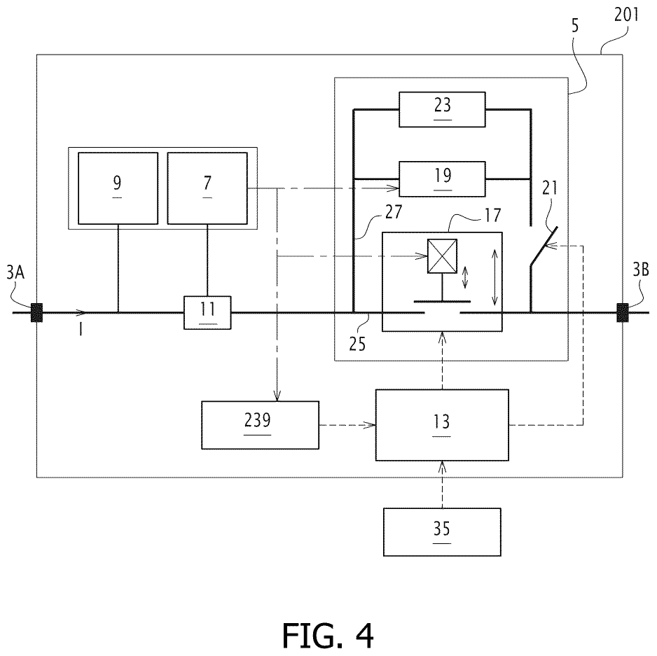

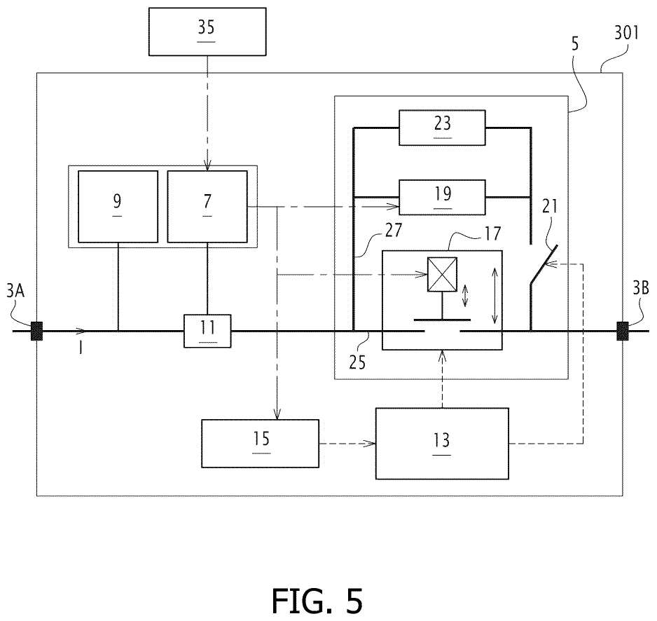

If the mechanical switch 17 is monostable, so that its open configuration may potentially be unstable while its closed configuration is stable, this safe operation is no longer assured. A third and a fourth embodiment, which are illustrated in FIGS. 4 and 5 respectively, propose hybrid circuit breaker architectures that ensure this safe operation when the mechanical switch 17 is monostable.

In these two embodiments, the monostable mechanical switch 17 depicted in FIGS. 2A to 2D advantageously comprises a release actuator 37. This release actuator 37 is configured to hold the mechanical switch 17 in its unstable configuration and to release the mechanical switch 17 into its stable configuration on the basis of a command from the control unit 7. In the example illustrated in FIGS. 2A to 2D, the release actuator 37 is releasing the mechanical switch 17 into its stable closed configuration in insert A, and is holding the mechanical switch 17 in its unstable open configuration in insert B.

FIG. 4 relates to a hybrid circuit breaker 201 according to the third embodiment of the invention. This hybrid circuit breaker 201 is identical to the hybrid circuit breaker 1 of FIG. 1, except for the differences mentioned hereinafter. Those features of the hybrid circuit breaker 201 that are identical to, or that operate in the same way as, those of the hybrid circuit breaker 1 bear the same reference symbol. Those features that are modified bear a reference symbol increased by 200.

The hybrid circuit breaker 201 differs from the hybrid circuit breaker 1 in that it comprises a locking device 239, in place of the trip unit 15.

Unlike the trip unit 15, the locking device 239 is configured to prevent the isolation mechanism 13 from resetting the switching device 5, i.e. from switching the mechanical switch 17 into one of its open or closed configurations and the isolating switch 21 into its closed configuration in the absence of confirmation from the control unit 7. The switching device 5 is then said to be locked.

The confirmation from the control unit 7 takes, for example, the form of status messages sent by the control unit 7 to the locking device 239 enabling the locking device 239 to determine whether or not the control unit 7 is operational. Locking is performed for example by means of a no-volts coil, which prevents the switching device 5 from being reset as long as the control unit 7 is not operational.

Advantageously, the locking device 239 also performs the functionalities of the trip unit 15 or 115. In an alternative that has not been depicted, the hybrid circuit breaker 201 comprises, in addition to the locking device 239, a trip unit 15 or 115.

This third embodiment makes it possible to prevent the operator 35 from resetting the switching device 5 by manual action on the isolation mechanism 13 while the control unit 7 is not operational.

FIG. 5 relates to a hybrid circuit breaker 301 according to a fourth embodiment of the invention. This hybrid circuit breaker 301 is identical to the hybrid circuit breaker 1 of FIG. 1, except for the differences mentioned hereinafter.

The hybrid circuit breaker 301 differs from the hybrid circuit breaker 1 in that the isolation mechanism 13 is configured to be tripped only by the control unit 7. In other words, in this embodiment, the isolation mechanism 13 cannot be tripped manually by the operator 35. Instead, the operator 35 may command the isolation mechanism 13 via the control unit 7, as illustrated in FIG. 5.

Thus, the command to reset the switching device 5 can be transmitted to the isolation mechanism 13 only if the control unit 7 is operational. If not, if the control unit 7 is not operational and therefore unable to detect and interrupt a faulty current, the control unit 7 is also unable to transmit the reset command to the isolation mechanism 13, and the switching device 5 is therefore not reset. The electrical locking may be said to be native inherent to the structure of the hybrid circuit breaker 301.

Furthermore, this fourth embodiment allows the operator 35 to control the mechanism 13 either locally, as in the other embodiments, or remotely, which may be advantageous for certain applications, notably in the event that the electrical installation is situated somewhere that is difficult to access.

The hybrid circuit breakers 201 and 301 of the third and fourth embodiments may be equipped with a trip unit 115 as in the second embodiment, in order to add additional safety to the hybrid circuit breaker 201 or 301.

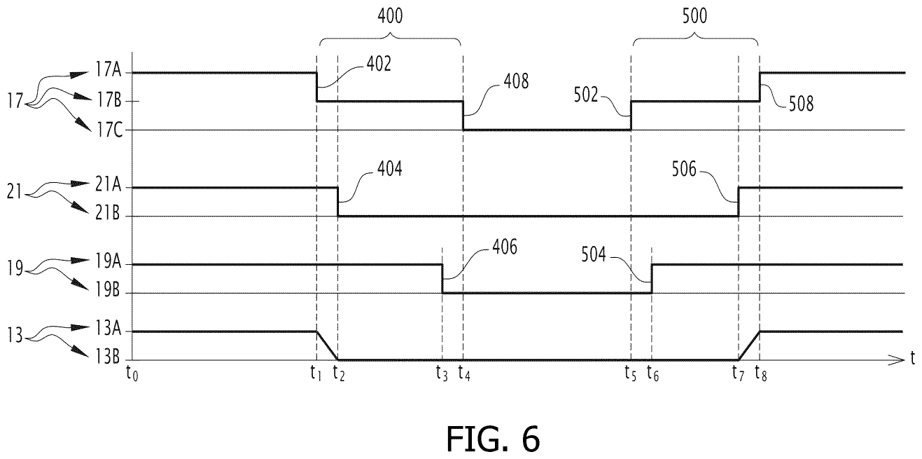

A method 400 for closing and a method 500 for opening the hybrid circuit breaker 1, 101, 201 or 301 are described later on in the description with reference to FIG. 6.

FIG. 6 is a timing diagram indicating the configurations of the various components of the hybrid circuit breaker 1, 101, 201 or 301 over the course of time t.

Starting from the top of the timing diagram, a first plot corresponds to the configurations of the mechanical switch 17 over the course of time t. A high position 17A corresponds to the mechanical switch 17 in its disconnect configuration, an intermediate position 17B corresponds to the mechanical switch 17 in its open configuration, and a low position 17C corresponds to the mechanical switch 17 in its closed configuration.

A second plot corresponds to the configurations of the isolating switch 21 over the course of time t. A high position 21A corresponds to the isolating switch 21 in its open configuration, and a low position 21B corresponds to the isolating switch 21 in its closed configuration.

A third plot corresponds to the configurations of the semiconductor component 19 over the course of time t. A high position 19A corresponds to the semiconductor component 19 in its non-conducting configuration, and a low position 19B corresponds to the semiconductor component 19 in its conducting configuration.

A fourth plot corresponds to the configurations of the isolation mechanism 13 over the course of time t. A high position 13A corresponds to the isolation mechanism 13 in its open configuration, and a low position 13B corresponds to the isolation mechanism 13 in its closed configuration.

Consider an initial instant t₀ at which the mechanical switch 17 is in its disconnect configuration, the isolating switch 21 is in its open configuration and the semiconductor component 19 is in its non-conducting configuration. By definition, the isolation mechanism 13 is then in its open configuration. In this configuration, galvanic isolation of the hybrid circuit breaker 1, 101, 201 or 301 is assured and no current flows through the hybrid circuit breaker 1, 101, 201 or 301.

At an instant t₁, the operator 35 or the control unit 7 commands closure of the hybrid circuit breaker 1, 101, 201 or 301. The closure method 400 that ensues has the purpose of re-establishing the flow of current I through the hybrid circuit breaker 1, 101, 201 or 301, while ensuring safe operation.

The closure method 400 comprises a first phase of closing, comprising a switching 402 of the mechanical switch 17 from its disconnect configuration to its open configuration and a switching 404 of the isolating switch 21 from its open configuration to its closed configuration.

In FIG. 6, the switching 402 of the mechanical switch 17 from its disconnect configuration to its open configuration occurs at the instant t₁ and the switching 404 of the isolating switch 21 from its open configuration to its closed configuration occurs at an instant t₂ distinct from the instant t₁. As an alternative, the two switchings 402 and 404 occur simultaneously, or else the switching 404 occurs before the switching 402.

At the end of the first phase of closing, the isolation mechanism 13 is by definition in its closed configuration. Thus, the galvanic isolation of the hybrid circuit breaker 1, 101, 201 or 301 is no longer in place. In this configuration, the hybrid circuit breaker 1, 101, 201 or 301 still opposes the flow of current, both in the main branch because of the mechanical switch 17 in the open configuration, and in the switching branch by means of the semiconductor 19 in the non-conducting configuration, but a leakage current is able to flow through these components.

Safe operation in the first phase of closing is assured differently depending on the embodiment of the invention. In the first and second embodiments, the bistable nature of the mechanical switch 17 ensures that the mechanical switch 17 is in the open configuration at the end of the first phase of closing. This then ensures that the switching device 5 is not reclosed on a short-circuit. In the third embodiment, the locking device 239 ensures that the switchings 402 and 404 occur only in the presence of confirmation from the control unit 7, thereby ensuring that the control unit 7 has the capability of commanding opening of the hybrid circuit breaker 201 in the event of a problem. In the fourth embodiment, the fact that the closure command has to pass through the control unit 7 ensures that the switchings 402 and 404 occur only if the control unit 7 is operational.

In order to fully re-establish the flow of current through the hybrid circuit breaker 1, 101, 201 or 301, the closure method 400 comprises a second phase of closing, comprising a switching 406 of the semiconductor component 19 from its non-conducting configuration to its conducting configuration and then a switching 408 of the mechanical switch 17 from its open configuration to its closed configuration.

In FIG. 6, the switching 406 of the semiconductor component 19 from its non-conducting configuration to its conducting configuration occurs at an instant t₃ and the switching 408 of the mechanical switch 17 from its open configuration to its closed configuration occurs at an instant t₄ distinct from and after the instant t₃.

At the end of the closure method 400, the current I once again flows through the hybrid circuit breaker 1, 101, 201 or 301, and the electrical installation is able to operate. This then is the mode of nominal operation of the electrical installation. More specifically, the current I flows in the main branch 25 and therefore does not pass through the semiconductor component 19 or the isolating switch 21, which are situated in the switching branch 27. Thus, as explained in the introduction, no heating occurs either in the isolating switch 21 or in the semiconductor component 19, thereby lengthening the service life of the semiconductor component 19.

Starting from this mode of nominal operation, in which the mechanical switch 17 is in its closed configuration, the semiconductor component 19 in its conducting configuration and the isolating switch 21 in its closed configuration, the operator 35, the control unit 7 or the trip unit 115 commands an opening of the hybrid circuit breaker 1, 101, 201 or 301 at an instant t₅. For example, this command is issued following detection, by the control unit 7, of an overcurrent, namely when the current-intensity value measured by the current sensor 11 exceeds the current threshold. The opening method 500 that ensues has the purpose of interrupting the flow of current I in the hybrid circuit breaker 1, 101, 201 or 301 so as to protect the electrical installation.

The opening method 500 comprises a first phase of opening, comprising a switching 502 of the mechanical switch 17 from its closed configuration to its open configuration then a switching 504 of the semiconductor component 19 from its conducting configuration to its non-conducting configuration.

In the example of FIG. 6, the switching 502 of the mechanical switch 17 from its closed configuration to its open configuration occurs at the instant t₅. The current is then diverted from the main branch 25 to the switching branch 27 comprising the semiconductor component 19. The switching 504 of the semiconductor component 19 from its conducting configuration to its non-conducting configuration then occurs at an instant t₆ distinct from and after the instant t₅.

At the end of the first phase of opening, the switching device 5 opposes the flow of current through the two branches. Owing to the characteristics of the semiconductor component 19 and of the mechanical switch 17, particularly of the opening actuator 31 for opening the mechanical switch 17, the first phase of opening is relatively rapid and allows the electrical installation to be made safe quickly. However, at the end of the first phase of opening, a leakage current can still flow through the switching device 5 because of the absence of galvanic isolation.

The opening method 500 therefore comprises a second phase of opening, comprising a switching 506 of the isolating switch 21 from its closed configuration to its open configuration and a switching 508 of the mechanical switch 17 from its open configuration to its disconnect configuration.

In FIG. 6, the switching 506 of the isolating switch 21 from its closed configuration to its open configuration occurs at an instant t₇ and the switching 508 of the mechanical switch 17 from its open configuration to its disconnect configuration occurs at an instant t₈ distinct from the instant t₇. As an alternative, the two switchings 506 and 508 occur simultaneously, or else the switching 508 occurs before the switching 506.

At the end of this second phase of opening, and therefore at the end of the opening method 500, the isolation mechanism 13 is by definition in its open configuration. In other words, the galvanic isolation of the switching device 5 is assured, both on the main branch 25 thanks to the mechanical switch 17 in the disconnect configuration, and on the switching branch 27 thanks to the isolating switch 21 in the open configuration. Thus, the electrical installation is protected against the leakage current.

Once an electrical fault responsible for the overcurrent has been resolved, the hybrid circuit breaker 1, 101, 201 or 301 can be reset according to the closure method 400.

Any feature described hereinabove for one embodiment or alternative variant may also be implemented in the other embodiments and alternative variants described hereinabove, insofar as it is technically feasible.

1. A hybrid circuit breaker, comprising:
a switching device comprising a main branch connecting two electrical terminals and a switching branch connecting the two electrical terminals and in parallel with the main branch, the switching device comprising:
a mechanical switch, belonging to the main branch, configured to switch between a closed configuration allowing current to flow in the main branch, and an open configuration opposing the flow of current in the main branch;
a semiconductor component, belonging to the switching branch, configured to switch between a conducting configuration allowing current to flow in the switching branch and a non-conducting configuration opposing the flow of current in the switching branch; and
an isolating switch, belonging to the switching branch, configured to switch by means of an isolation mechanism between a closed configuration allowing current to flow in the switching branch, and an open configuration opposing the flow of current in the switching branch, the isolating switch having, in the open configuration, a resistance to the passage of current in the switching branch that is higher than a resistance to the passage of current in the switching branch of the
semiconductor component in the non-conducting configuration;
a control unit, configured to command a switching of the mechanical switch between its open configuration and its closed configuration, of the semiconductor component between its non-conducting configuration and its conducting configuration, and of the isolating switch between its closed configuration and its open configuration via the isolation mechanism, depending on the incoming current passing through the hybrid circuit breaker between the two electrical terminals;
characterized in that the mechanical switch is also able to switch, by means of the isolation mechanism, into a disconnect configuration, distinct from the open configuration and from the closed configuration, that opposes the flow of current in the main branch, and such that a resistance to the passage of current in the main branch of the mechanical switch in the disconnect configuration is greater than the resistance to the passage of current in the main branch of the mechanical switch in the open configuration.

2. The hybrid circuit breaker according to claim 1, wherein the isolation mechanism is further configured to be tripped by manual action by an operator.

3. The hybrid circuit breaker (301) according to claim 1, wherein the isolation mechanism is configured to be tripped only by the control unit.

4. The hybrid circuit breaker according to claim 1, further comprising a locking device configured to prevent the isolation mechanism from switching the mechanical switch into one of its open or closed configurations and the isolating switch into its closed configuration in the absence of confirmation from the control unit .

5. The hybrid circuit breaker according to claim 1, further comprising a trip unit configured to receive a measurement of the incoming current and to command the isolation mechanism to switch the mechanical switch into its disconnect configuration and the isolating switch into its open configuration when the incoming current exceeds a predetermined current threshold.

6. The hybrid circuit breaker according to claim 1, wherein the mechanical switch is bistable, i.e. the open configuration and the closed configuration of the mechanical switch are stable.

7. The hybrid circuit breaker according to claim 1, wherein the mechanical switch is monostable.

8. The hybrid circuit breaker according to claim 1, further comprising a screen opposing the flow of current in the main branch when the mechanical switch is in its disconnect configuration.

9. A method for opening a hybrid circuit breaker according to claim 1, the mechanical switch being initially in its closed configuration, the semiconductor component in its conducting configuration and the isolating switch in its closed configuration, the opening method comprising:
a first phase of opening, comprising a switching of the mechanical switch from its closed configuration to its open configuration then a switching of the semiconductor component from its conducting configuration to its non-conducting configuration; then
a second phase of opening, comprising a switching of the isolating switch from its closed configuration to its open configuration and a switching of the mechanical switch from its open configuration to its disconnect configuration.

10. A method for closing a hybrid circuit breaker according to claim 1, the mechanical switch being initially in its disconnect configuration, the semiconductor component in its non-conducting configuration and the isolating switch in its open configuration, the closing method comprising:
a first phase of closing, comprising a switching of the mechanical switch from its disconnect configuration to its open configuration and a switching of the isolating switch from its open configuration to its closed configuration; then
a second phase of closing, comprising a switching of the semiconductor component from its non-conducting configuration to its conducting configuration then a switching of the mechanical switch from its open configuration to its closed configuration.
